(19) United States
(12) Patent Application Publication
(10) Pub. No.: US 2017/0300177 A1
(43) Pub. Date: Oct. 19, 2017

(54) System and Methods for Retrieving Related Content from a First Application and Displaying Related Content on a Browser Accessing a Web Application

(71) Applicant: Lexmark International Technology, Sarl, Meyrin (CH)

(72) Inventor: Shane Evan Blazek, Shawnee, KS (US)

(21) Appl. No.: 15/132,764

(22) Filed: Apr. 19, 2016

(51) Int. Cl. G06F 3/0481; G06F 17/30; G06F 3/0484; G06F 17/22; H04L 29/08

(52) U.S. Cl. CPC G06F 3/0481; H04L 67/02; G06F 17/30882; G06F 3/04842; G06F 17/2247; G06F 17/30873

(57) ABSTRACT

A method for displaying related content from one application on an interface of another web application based on a context in the web application includes receiving a request from a user to display the related content from the first application while the user is accessing the second application on a window of a browser and identifying a context in the second application. The method further includes searching for the related content based on the value corresponding to the context and displaying on the window of the browser that is accessing the second application the related content returned by the searching.

### CROSS REFERENCE TO RELATED APPLICATIONS

This patent application is related to the United States patent application Ser. No. ______, entitled “System and Methods for Syncing Web Application Records Across Multiple Browser Windows,” filed contemporaneously herewith and assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### BACKGROUND

### 1. Technical Field

The present disclosure relates to displaying content from one application to another. More particularly, it relates to a method of retrieving and displaying related content from a first application to an interface of a second application based on a context in the second application.

### 2. Description of the Related Art

Various enterprises and businesses often employ a number of web applications to manage content pertaining to their business. Businesses may use enterprise content management (ECM) applications that typically contain information that may be separate and distinct from information that are managed using other ECM applications that the business might use. For example, employee information contained in a human resources management web application may be different from but related to employee information contained in a payroll management web application such as, for example, when an employee “John Smith” has records that are contained in both the human resources management web application and the payroll management web application.

While this scheme may be effective in managing content for a certain organization within a business or enterprise, it presents some difficulty when a user needs to access content found in one web application that may be related to a specific context being accessed by the user in another web application. For example, the user may be accessing HR content for an employee name “John Smith”, and may need to retrieve content from the payroll management web application that is related to the same employee “John Smith”.

In one example case scenario, a user may access a web page on a first web application (e.g., HR web application) using a first browser window. The web page may contain context such as, for example, records of an employee “John Smith”. If the user needs to access content stored in another application (e.g., payroll application) that is related to the context being accessed on the first browser window (e.g., “John Smith”), the user typically has to open the payroll application which may be a desktop application, and perform the search for the content from the payroll desktop application. If the payroll application is a web application, the user typically has to open a second web browser or browser window, log on to the payroll web application using the second browser window, and conduct a search for a list of documents or for content in the payroll web application that is related to the “John Smith” context that is being accessed by the user in the HR web application.

One way to solve this difficulty would be to add certain functionalities to one application that would allow it to interface with another application. However, there is some disadvantage to this as the two applications may have been created or maintained by different service providers, and as such, may not be compatible with each other. Further, the installation of such functionality may involve making changes to the software and programming of both applications which may be cumbersome and time-consuming. Moreover, a business may employ any number of applications for managing content, and having more than two of these applications interface may not always be efficient, if such a scheme is possible at all.

Accordingly, a need exists in the art for a system and methods for allowing a browser window that is accessing a web application to display content retrieved from another application without switching to another window to access the other application or leaving the first browser window to access the other application. What is also needed is a method of automatically retrieving, from another application, content related to a context being accessed on a browser window of a web application and displaying the related content on the browser window of the web application. Additional benefits and alternatives are also sought when devising solutions.

### SUMMARY

A system capable of and methods for displaying related content from a first application to a browser accessing a second application are disclosed. One example method includes retrieving content from a web application, the content being related to a context displayed on a first application and then displaying the retrieved content on a first browser window accessing the first application. The example method includes receiving a request from a user to display content from the first application while the user is accessing the second application on a window of a browser, and identifying a context in the second application. A value corresponding to the context in the second application may then be retrieved and used to search for the content from the first application. The content returned by the search may then be displayed on the window of the browser that is accessing the second application.

In one aspect of the example embodiment, the receiving, the identifying, the retrieving, the searching, and the displaying may be performed without the user switching to a window of the browser that is accessing the first application. In another aspect of the example embodiment, searching for the content from the first application may be performed in the background and simultaneous with the user accessing the second application.

In another aspect of the example embodiment, identifying the context in the second application includes identifying an element in the second application that contains data relevant to the first application. In yet another aspect of the example embodiment, receiving the request from the user may be performed by the user selecting a bookmarklet on the browser used to access the second application.

From the foregoing disclosure and the following detailed description of various example embodiments, it will be apparent to those skilled in the art that the present disclosure provides a significant advance in the art of displaying related content from one web application to an interface of another web application based on a context in the second web application. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is one example embodiment of a system including a client device having a browser, the client device connected to a server computer via a network.

FIGS. 2a and 2b illustrate an example setup page for installing a bookmarklet associated with a first application.

FIG. 3 shows an example method for retrieving related content from first application to be displayed on a second web application being accessed on a browser window of the browser using the installed bookmarklet.

FIGS. 4a and 4b show an example web application being accessed by the user using browser having an installed bookmarklet.

FIG. 5 is an example source reference of an application that includes a specified element and example HTML elements.

### DETAILED DESCRIPTION OF THE DRAWINGS

The following description and drawings illustrate embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some example embodiments may be included in or substituted for those of others. The scope of the present application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity but rather denote the presence of at least one of the referenced item.

It will be further understood that each block of the example flowcharts or diagrams, and combinations of blocks in the example flowcharts or diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the description below.

These computer program instructions may also be stored in a non-transitory computer-readable memory that may direct a computer or other programmable data processing apparatus to function in a particular manner, such that the instructions stored in the computer-readable memory produce an article of manufacture, including an instruction means that implements the function specified in the block or blocks. The computer program instructions may also be loaded onto a computer or other programmable data processing apparatus to cause a series of operational actions or steps to be performed on the computer or other programmable apparatus to produce a computer implemented process such that the instructions that execute on the computer or other programmable apparatus implement the functions specified in the block or blocks.

Accordingly, blocks of the example flowcharts and diagrams support combinations of means for performing the specified functions, combinations of actions or steps for performing the specified functions and program instruction means for performing the specified functions. It will also be understood that each block of the diagrams, and combinations of blocks in the diagrams, may be implemented by special purpose hardware-based computer systems or combinations of special purpose hardware and computer instructions that perform the specified functions, actions or steps.

Disclosed is a system and methods for retrieving content from a first application, the content being related to a context being displayed on a second web application and then displaying the retrieved content on a browser window accessing the second web application. The retrieving and the displaying may be performed without the user switching to the first application or without the user interacting directly with the first application. In another example embodiment, the retrieving and the display may be performed without the user leaving the second web application. The retrieving and the displaying may also be performed without modifying any of the applications specifically for this integration, and without any of the applications being made aware that the retrieving and the displaying are performed.

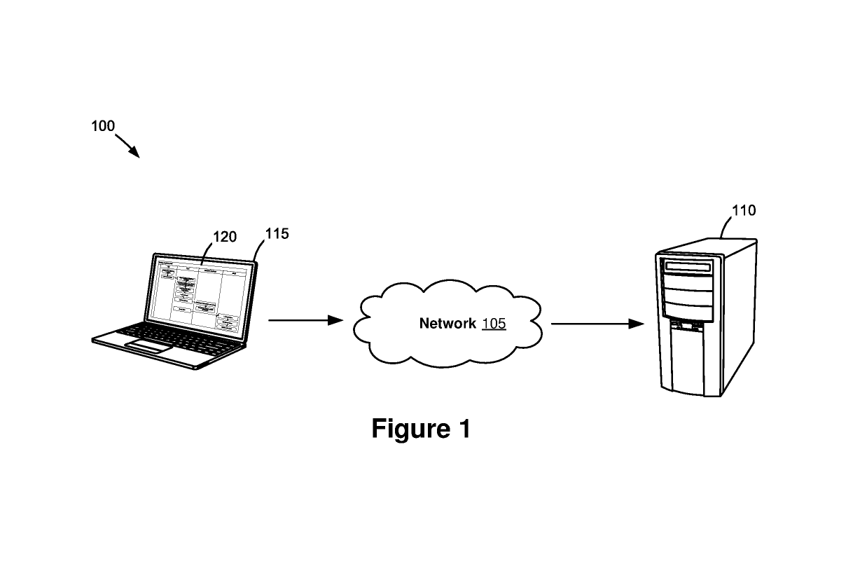

FIG. 1 shows one example embodiment of a system 100 for use in displaying related content in a first application based on searching a second web application for the related content, the searching based on information found in the first application. System 100 may be used in retrieving content from a second web application, the content being related to a context displayed on a first application and then displaying the retrieved content on a first browser window accessing the first application.

System 100 includes a network 105 and a server computer 110 communicatively connected to a client device 115 through network 105. Network 105 is any network, communications network, or network/communications network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, as discussed herein, and/or available or known at the time of filing, and/or as developed after the time of filing.

Server computer 110 may be a computing device that hosts content to be accessed by client device 115 through network 105. Examples of server computer 110 may include but are not limited to a personal computer, a server computer, a series of server computers, a mini computer, and a mainframe computer. Server computer 110 may also be a web server (or a number of web servers) that hosts data records that may be accessed by a user through one or more web applications opened using browser 120. In another example embodiment, server computer 110 may be a server that hosts an application for use in retrieving content from one accessed web application to be displayed in another web application accessed using a different browser window or tab of browser 120.

Client device 115 may be a personal computer, as shown in FIG. 1 that may be used by a user to access content and one or more records using browser 120. In alternative example embodiments, client device 115 may be any computing device capable of executing applications therein such as, for example, mobile phones, laptops and tablet computers. Client device 115 may include a processor (not shown) and a computer-readable medium (not shown), such as a random access memory (RAM), coupled to the processor. The processor may execute computer-executable program instructions stored in the memory. Computer-executable program instructions may include a set of instructions for executing browser 120 such as, for example, a web browser for use in opening web applications.

Browser 120 may be an application installed in client device 115 that is used to retrieve, render and present resources such as, a web page, image, video, or other piece of content on the World Wide Web (WWW). Browser 120 may be used to execute one or more software applications that are used for accessing data records. In one example embodiment, browser 120 may be a web browser or any other similar program that accesses information from the WWW, or from a remote computer, such as server computer 110.

Browser 120 may be used to display one or more web applications. Web applications may be any software that runs in a web browser such as, for example, browser 120. Examples of web applications may be a web page or any web content capable of being rendered in browser 120. Web applications may be created in a browser-supported programming language such as, for example, hypertext markup language (HTML), JavaScript, CSS, and the like. Browser 120 may display a plurality of web applications at a time through browser tabs or windows, as will be known in the art.

With continued reference to FIG. 1, browser 120 may include an application such as, for example, a bookmark, a bookmarklet, or a browser extension. A bookmark may refer to a tool used to access specific web pages without requiring the user to type the web page address on the address box of browser 120. A bookmark may be a Uniform Resource Identifier (URI) that directs the browser 120 to a specific web page or application. A URI, as is known in the art, is a string of characters that identifies and allows interaction with a resource within a computer system, such as the World Wide Web or network 105. The most common form of a URI is a Uniform Resource Locator (URL), commonly referred to as a web address.

A bookmarklet may refer to a tool for extending the functionality of browser 120. A bookmarklet may be a Uniform Resource identifier (URI). However, instead of directing to a specific web page, a bookmarklet contains commands to extend the functionality of browser 120. The commands may be in a programming language used in browser 120, such as, for example, JavaScript. JavaScript is a programming language most commonly used as part of web browsers. When executed, a bookmarklet may perform one of a variety of functions such as, for example, a search query or data extraction.

In one embodiment of the present disclosure, a bookmarklet may be used to display content from a first application related to a term, such as a name, that is being accessed on a second application. At least one of the first and the second applications may be applications installed and/or executed on client device 115 such as, for example, desktop applications. In another example embodiment, the first and/or the second applications may be web applications such as, for example, software or application programs that may be stored on a remote server such as server computer 110 and delivered over a network through an interface of browser 120.

For illustrative purposes, a user of client device 115 has a tab of browser 120 open on an HR web application with an employee record page “John Smith” being accessed. The user may wish to view the employee's pay stubs that are stored in an ECM web application which is normally accessed via another web application using another window or tab of browser 120. Instead of manually opening a new window or new tab of browser 120 to the ECM web application and searching for the employee, the user may click an installed bookmarklet that finds and extracts the employee name (e.g., “John Smith”) on the current page in the HR web application, runs a search on the ECM web application using the employee name, and displays related content directly on the same page of the HR web application, without leaving the open tab of the HR web application in browser 120.

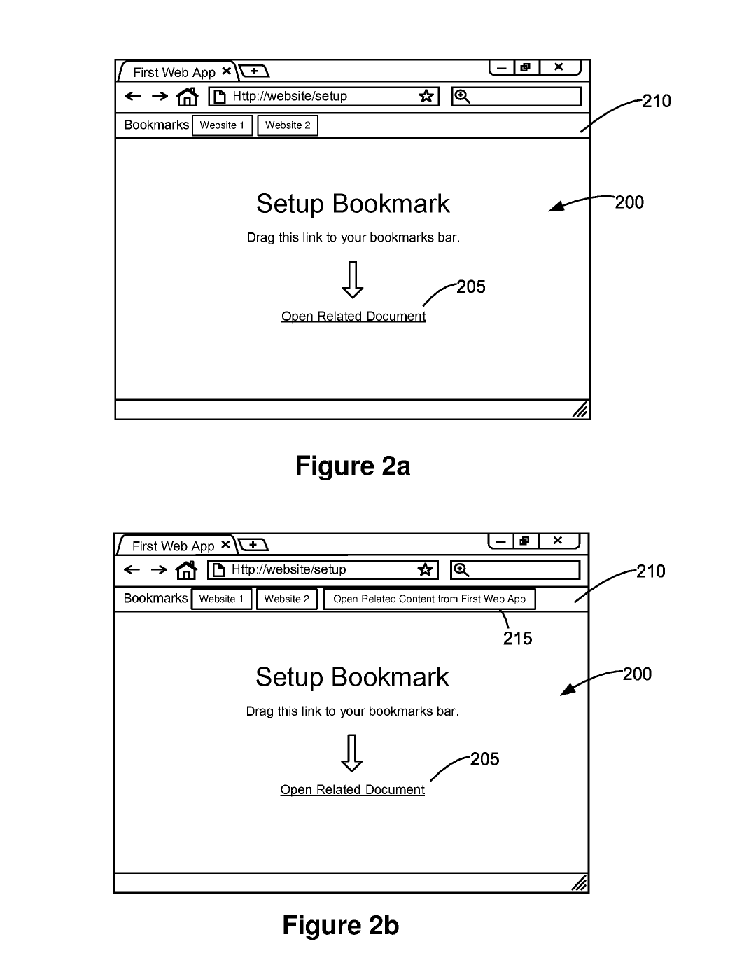

FIGS. 2a and 2b illustrate an example setup page for installing a bookmarklet associated with a first application. For illustrative purposes, a bookmarklet will be used to describe the present disclosure but it will be understood that a bookmark, a browser extension, and the like may also be used to perform the methods as will be discussed in greater detail below. For illustrative purposes, the first application may be a web application to be accessed using a window of browser 120 but it will be understood that the first application may also be a desktop application executed in client device 115.

The bookmarklet may be used to retrieve content from the first application to be displayed in a window of browser 120 that is accessing a second web application. As shown in FIG. 2a, the user of client device 115 may navigate to a setup page 200 to install the bookmarklet associated with the first application. Open Related Document link 205 may be a URI of the bookmarklet associated with the first application, and the user may drag the Open Related Document link 205 to a bookmarks bar 210 of the browser window to install the bookmarklet. In one example embodiment, Open Related Document link 205 may be embedded into setup page 200 as a code such as, for example, a JavaScript code. In alternative example embodiments, the bookmarklet may be installed on browser 120 using an installation script or manually by the user using a bookmarklet code.

An example installed bookmarklet is shown as bookmarklet 215 in FIG. 2b, in the bookmarks bar 210 of browser 120. Once installed, bookmarklet 215 may be clicked by a user while accessing a second web application on browser 120 to display related content retrieved from the first application. Clicking on bookmarklet 215 to display the related content on the browser accessing the second web application allows the user to view content from the first application that is related to a context that he or she is accessing on the second web application without having to leave the second web application.

Bookmarklet 215 allows the user accessing a second web application to display content from the first application, the content searched from the first application based on a context being displayed on the second web application. Bookmarklet 215 may perform the retrieving of the content from the first application in the background such that the user is not required to leave the second web application in order to retrieve the content to be displayed. A user such as, for example, an administrative user may access a configuration tool user interface or a configuration file that allows the admin user to specify one or more settings for bookmarklet 215.

In one example embodiment, the administrative user may be given access to settings that allow the user to specify an application such as a software web application to be used with bookmarklet 215. For example, the user may indicate an identifier of an application such as, for example, an application label “HR,” which bookmarklet 215 may use to identify that the application is supported by bookmarklet 215. An identifier for the application may include a Uniform Resource Locator (URL) of the first application, a descriptive text associated with the application such as, for example, a title located in the title bar of browser 120, and other identifiers as will be known in the art.

In one example embodiment, the administrative user may specify which fields from the second web application to get data from, and specify how to generate a search URL from the selected fields such as, for example, ?name=[NAME_FIELD_VALUE]&birthday=[BIRTHDAY_FIELD_VALUE]. In one example embodiment, bookmarklet 215 may be configured to identify one or more specific elements in a web application executed using browser 120. Bookmarklet 215 may determine which applications, URLs, fields, or other elements in the application are to be extracted from. These settings may be configured by a user such as an administrator for one or more users of a client device 115 having browser 120 installed with bookmarklet 215. The settings may be stored in a location bookmarklet 215 can retrieve upon execution such as, for example, a text file, a memory, a remote server or a database communicatively connected with bookmarklet 215.

When activated, bookmarklet 215 may retrieve values from the element for use in identifying and retrieving relevant content from the first application executed using browser 120. The value of the element may be sent to the first application for example, directly from the second application to the first application, or via one or more URL parameters. The relevant content may be retrieved from the first application based on information displayed in the second web application such that a retrieval of relevant content is performed on the first application using data currently being accessed in the second web application. The retrieval of relevant content using bookmarklet 215 may enable the second web application executed in browser 120 to display related content from the first application without leaving the second web application to retrieve the data from the first application.

In an alternative example embodiment, the fields or elements from which data will be extracted by bookmarklet 215 may be unique for every web application that has been set as being supported by bookmarklet 215. For example, when the second web application being accessed is an HR application, bookmarklet 215 may be configured to extract data from specific fields or elements in the HR application. If the second web application being accessed is a payroll application, bookmarklet 215 may be configured to extract data from fields or elements that are specific for the payroll application.

Display options may also be provided to the administrative user such as options on how to display the related content when bookmarklet 215 is activated such as, for example, whether the related content will be displayed on some extended portion of the web page, as a pop-up window, or as an inline, floating object on the web page. In some example embodiments, bookmarklet 215 may be generated based on a user's login credentials, such that bookmarklet 215 may allow the user clicking installed bookmarklet 215 to display only related content from the first application that the user has permission to access.

In yet other example embodiments, bookmarklet code may be generated to allow installed bookmarklet 215 to generate a search term for use to search for specific data that is relevant or common between the first and second applications. Search terms may be data retrieved from the second web application that are then used to retrieve content from the first application. Bookmarklet 215 may be configured to only retrieve data from second web application that is relevant to the first application, such that the data may return results that are pertinent to the second web application. For example, bookmarklet 215 may be configured to retrieve data such as, employee name, employee ID, and the like, from the second web application since the first application may store content that is associated with only the employee name, employee ID, etc., of the second web application, thereby precluding other data that second web application may also include such as nickname, or designation.

The bookmarklet code may then be generated using a pre-created code that takes the settings configured by the administrative user including the search options and the selected fields, to be used to generate bookmarklet 215. The settings may be stored on a user's system such as, for example, a file, a database, or a local storage system. The settings may also be retrieved from a remote system such as, for example, a remote server, a database or a service, as will be known in the art.

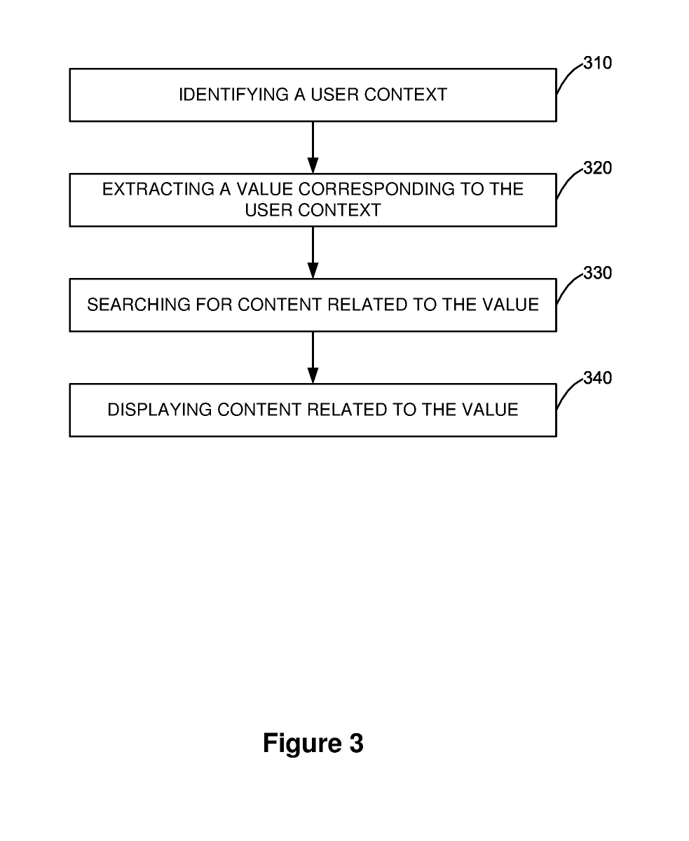

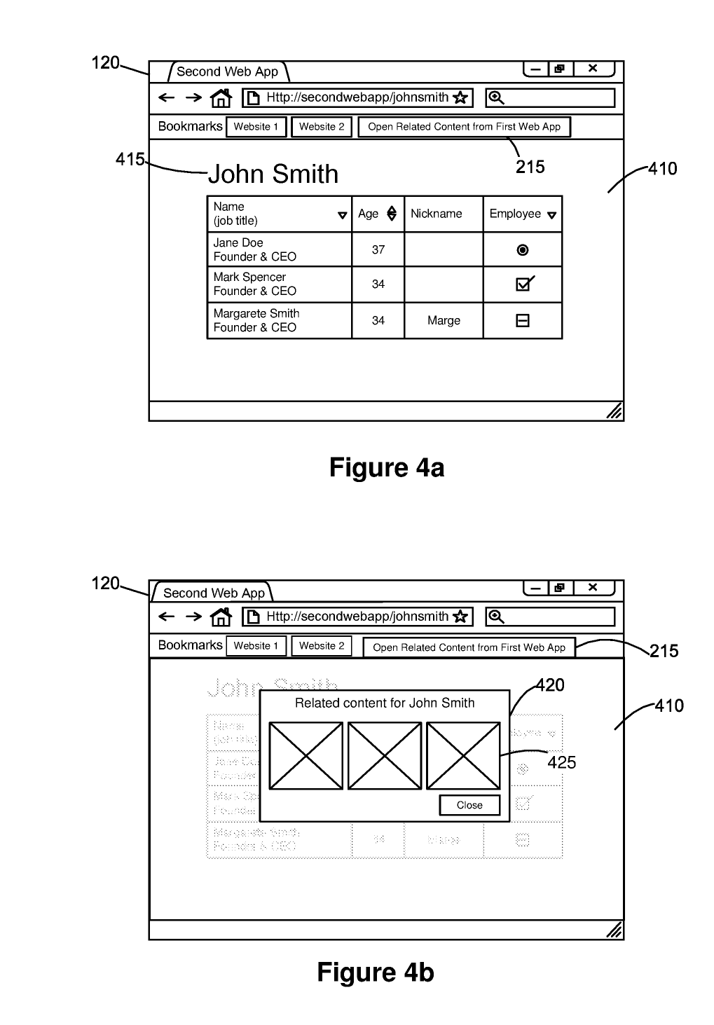

FIG. 3 shows an example method 300 for retrieving related content from a first application to be displayed on a second web application being accessed on a browser window of browser 120 using installed bookmarklet 215. Method 300 may be performed when a user accessing the second web application using a browser window clicks on installed bookmarklet 215. In one example embodiment, bookmarklet 215 may perform method 300 when activated by the user such as, for example, when clicked by the user. FIGS. 4a and 4b show an example second web application being accessed by the user using browser 120 having installed bookmarklet 215. FIGS. 4a and 4b includes an example HR web application page 410 including a user context 415. For illustrative purposes, a user of client device 115 may be accessing example HR web application page 410 on a window or tab of browser 120. Browser 120 may be installed with a bookmarklet 215, and when the user clicks on bookmarklet 215, method 300 may be performed. The user may activate bookmarklet 215 when, for example, the user wishes to view related content of “John Smith” user context 415 such as the employee's pay stubs that may be stored in the first application. Method 300 may be performed by bookmarklet 215 in the background without the user leaving the browser that is accessing web application page 410, as shown in FIG. 4a.

At block 310, a user context 415 may be identified from the second web application. User context 415 may be context or data that is rendered by example HR web application 410 and found in an element configured to be an element from which bookmarklet 215 may extract values to be used as part of a search query. The search query will be used to retrieve content from the first application. Identifying user context 415 for the second web application may be performed by checking an identifier of the second web application and checking if the second web application identifier is associated with at least one element that has been configured to be an element from which a value may be extracted.

For example, an identifier for the second web application may be “Second Web App” and determining if the second web application includes at least one element to be extracted may be performed by retrieving at least a part of the title of the second web application, such as “Second Web App”, and determining if the “Second Web App” application has at least one element to be extracted, such as for example, the element containing a value in element 415. A list of applications having an element to be extracted and are support by bookmarklet 215 may be stored in a database communicatively connected to bookmarklet 215.

Alternatively, bookmarklet 215 may include settings that allow a user to select one or more elements in the second web application having a value to be extracted from, the value to be used to retrieve data from the first application. For example, a user may specify before or during the accessing of Second Web App in browser 120, one or more elements that may contain values that can be used to retrieve related content from the first application.

In one example embodiment, user context 415 may be a Hypertext Markup Language (HTML) tag or HTML user interface (UI) element, container, or variable that contains information, data or value that may be used to search for content in another application such as the first application. The HTML elements may be components of an HTML document and the information, data or value may include such other HTML elements, text, and the like.

User context 415 may be contained in a specified element in bookmarklet 215. The element may be characterized as any data type capable of being recognized by an application, such as, for example, a label, a string identifier, a number identifier, or any string of text. User context 415 may, for example, be an account name, date, employee identification number, customer number, and the like. In another example embodiment, user context 415 may be logical location of data or information in a source reference of the web application that may be defined by a user and characterized by the user as being a particular type of data. A source reference, as used herein, refers to a set of instructions, code, and/or values such as those that are rendered for the display of the second web application.

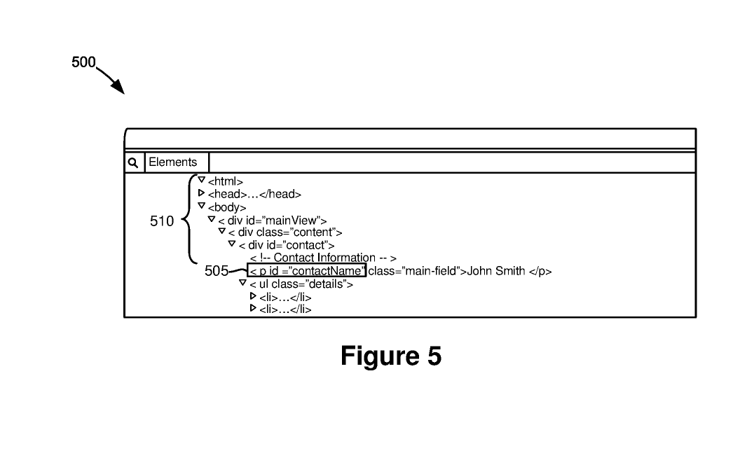

FIG. 5 shows an example source reference 500 of an application that includes a specified element 505 and example HTML elements 510 that define how the HTML web page of an application is rendered and displayed in browser 110. In this example source reference 500, the example HTML elements 510 are for the example second web application. For illustrative purposes, element <p id=“contactName”>505 is the HTML element to be extracted and whose value will be retrieved by bookmarklet 215. Element 510 may be defined by the user using bookmarklet 215, or an application communicatively connected to bookmarklet 215. Element 510 and other elements in the second web application that are configured to be used by bookmarklet 215 to search for related content from the first application may be stored in a computer storage media and organized in a database, and the like.

In another example embodiment, elements 510 may be a rendered source reference. For example, elements 510 may be defined as a tree node, an object, coordinates of a display or other user interface screen, a window control or relative to a window control, or using another data location method. In yet another example embodiment, elements 510 may be an area of a display containing value that has been defined and characterized by a user of the bookmarklet 215. In this aspect, elements 510 may be identified by its spatial location within a display rendered by an application executed using browser 120, such as through one or more coordinates. A display, as used herein, refers to a presentation of an image, document, user interface, and/or other value to a display device. For example, user interface screens for the second web application, including user interface screens that visually present user context 415, may be displayed. One or more displays generated by the second web application may have one or more defined elements 510.

In some example embodiments, user context 415 may be configured during the generation of the bookmarklet code for use in the installation of bookmarklet 215. In other example embodiments, the user context 415 may be specified by the user after being prompted upon activating bookmarklet 215. In still other example embodiments, the user may also be prompted for login credentials for the first application from which bookmarklet 215 was generated. In yet other example embodiments, upon activating bookmarklet 215, the user may also be prompted with a list of options for displaying the related content on the interface of the second web application.

Referring back to FIG. 3, at block 320, a value corresponding to user context 415 identified at block 310 may be extracted from HR web application page 410. For example, the value “John Smith” is extracted from user context 415 in web application 410.

In one example embodiment, retrieving the value from the specified element includes collecting data from the element of the source reference or the display generated by the one of the applications. For example, the source reference for an HTML page is the HTML code and the value for the HTML page is collected before, during, and/or after the HTML page is rendered as a display. In this example, bookmarklet 215 may collect application data from the HTML source reference before, during, and/or after rendering the HTML display. In another example, the element may be a raster image or a bitmap image. In this example, bookmarklet 215 collects the value from the source reference image before, during, or after the image is rendered as a display.

In one alternative example embodiment, data corresponding to user context 415 may be extracted from a Document Object Model (DOM) of HR web application page 410. The DOM, as is known in the art, is a platform-independent and language-independent convention for representing and interacting with objects in HTML, XHTML, and XML documents such as example HR web application page 410. The value corresponding to user context 415 may be extracted from the element configured by the user to correspond to user context 415 for the second web application.

At block 330, the extracted value may be used to search for related content in the first application. The extracted value may be used as a search query to search for related content in a repository associated with the first application, thereby retrieving content related to the value in user context 415. In some example embodiments, the extracted value may be used to generate a URL that represents a search for related content using the extracted value as a search query. For example, for the extracted value “John Smith”, a URL such as “applicationl.com?searchQuery=john_smith” may be generated. This generated URL may then be used at block 340 to display the retrieved related content.

Related content may include documents, images, web pages, and/or other content stored using the first application that is associated with user context 415. Retrieving the value from user context 415 and using it to search for related content on the first application allows system 100 to search for related content between two web applications without integrating the two web applications, and without the first or the second web applications being made aware that a search is being performed. The search may be performed in the background while the user is accessing the second web application such that the user may not exit the second web application or switch to the first application in order to access related content.

In one example embodiment, the value to be used in searching for content in the first application may be transformed into a format that is relevant to the first application. For example, bookmarklet 215 may retrieve the value “John Smith” from the user context. The value may be converted to a search string such as, “&query=johnsmith&fullresults=true&folder=JohnsEmployee” that will be passed to the first application for use in searching content based on the “John Smith” value.

Alternatively, the values may also be transformed such as, for example, turning a first element value, and a second element value to a single string that is passed to the second application. In another alternative example embodiment, a substitution string may be used such as, for example, retrieving one or more values from one or more elements of the first application and substituting the one or more values into variable portions of a string. For example, if values “John,” “Smith,” and “Corporation” are retrieved from one or more elements of the first application, the values may substitute an example string: “&query={Name}{LastName}&employeer={Employeer}” thereby creating a “&query=JohnSmith&employeer=Corporation”.

At block 340, the related content retrieved from the first application is displayed on the example web application page 410. In one example embodiment, bookmarklet 215 may insert a new DOM object 420 into the web page 410 upon which to display the related content search results 425, as shown in FIG. 4b.

In other example embodiments, new DOM object 420 may show options for displaying related content search results 425, such as displaying related content search results 425 in a list or thumbnail form. In yet other example embodiments, bookmarklet 215 may expand web page 410 and display related content search results 425 on the expanded area, such as, for example, at a bottom section of web page 410.

The user may be provided one or more options for viewing the related content search results 425 on the generated DOM object 420 such as, for example, opening the related content search results 425 by replacing the URL in the current window or tab of browser 115 with the URL of the selected related content search results, or by opening the selected related content search results 425 in a new window or tab of browser 120.

It will be appreciated that the actions described and shown in the example flowcharts may be carried out or performed in any suitable order. It will also be appreciated that not all of the actions described in FIG. 3 needs to be performed in accordance with the example embodiments of the disclosure and/or additional actions may be performed in accordance with other embodiments of the disclosure.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific example embodiments disclosed and that modifications and other embodiments are intended to be included within the scope of the appended claims. Although specific terms are employed herein, they are used in a generic and descriptive sense only and not for purposes of limitation.

What is claimed is:

1. A method of displaying related content from a first application on an interface of a second application, comprising:
receiving a request from a user to display the related content from the first application, the receiving performed while the user is accessing the second application on a window of a browser;
identifying a context in the second application;
retrieving a value corresponding to the context in the second application;
searching for the related content based upon the value corresponding to the context; and
displaying the related content returned by the searching on the window of the browser that is accessing the second application.

2. The method of claim 1, wherein the searching for the related content is performed in the background and simultaneously with the user accessing the second application.

3. The method of claim 1, wherein the receiving the request from the user is performed by the user selecting an application installed in the browser that is configured to perform the identifying, the retrieving, the searching and the displaying.

4. The method of claim 3, wherein the receiving the request from the user is performed by the user selecting a bookmarklet on the browser.

5. The method of claim 1, wherein the identifying the context in the second application includes identifying an element in the second application that contains data relevant to the first application.

6. The method of claim 1, wherein the displaying the related content returned by the searching on the window of the browser that is accessing the second application includes displaying the related content in a generated document object model (DOM) element in the window of the browser that is accessing the second application.

7. The method of claim 1, wherein the receiving, the identifying, the retrieving, the searching, and the displaying are performed without the user interacting with a user interface of the first application.

8. A method for displaying related content from a first application on a browser accessing a web application, comprising:
receiving by a browser application a request from a user to display the related content from the first application, the receiving performed while the user is accessing the web application on a window of the browser;
identifying by the browser application a context being accessed in the web application;
retrieving by the browser application a value corresponding to the context being accessed in the web application;
searching by the browser application for the related content from the first application using the value corresponding to the context being accessed in the web application; and
displaying by the browser application the related content on the window of the browser being used by the user to access the web application.

9. The method of claim 8, wherein the displaying by the browser application of the related content includes generating a user interface to display the related content, the user interface overlaying the web application being accessed on the window of the browser.

10. The method of claim 8, wherein the receiving, the identifying, the retrieving, the searching, and the displaying are performed without the user leaving the window of the browser being used by the user to access the web application.

11. The method of claim 8, wherein the identifying by the browser application a context being accessed in the web application includes retrieving by the browser application the context associated with the web application from a configuration file.

12. The method of claim 8, wherein the identifying by the browser application a context being accessed in the web application includes identifying a hypertext markup language (HTML) element in the web application having the value configured to be retrieved and to be used for the searching the related content from the first application.

13. The method of claim 8, further comprising generating a search query using the retrieved value corresponding to the context being accessed in the web application, the search query for use in searching for the related content from the first application.

14. A computing device having a non-transitory computer readable storage medium containing one or more instructions for displaying related content from a first application to a browser displaying a web application, the one or more instructions comprising:
receiving by an application installed in the browser a request from a user to display the related content from the first application, the receiving performed while the user is accessing the web application on a window of the browser;
identifying by the application a context being accessed in the web application;
retrieving by the application a value corresponding to the context being accessed in the web application;
searching by the application for the related content from the first application using the value corresponding to the context being accessed in the web application; and
displaying by the application the related content on the window of the browser being used by the user to access the web application.

15. The computing device of claim 14, further comprising one or more instructions for determining user credentials prior to the searching by the browser application for the related content from the first application.

16. The computing device of claim 15, wherein the one or more instructions for displaying the related content include displaying the related content from the first application that is associated with the user credentials.

17. The computing device of claim 14, further comprising one or more instructions for generating by the application a search query based on the retrieved value corresponding to the context being accessed in the web application, the search query for use in searching for the related content from the first application.

18. The computing device of claim 14, further comprising one or more instructions for transforming the retrieved value into a format that is relevant to the first application and generating the search query using the transformed value.

19. The computing device of claim 14, wherein the one or more instructions for identifying by the application the context being accessed in the web application includes determining if the web application is displaying a specific context as specified in one or more settings of the application installed on the browser.

20. The computing device of claim 14, wherein the one or more instructions for retrieving the value corresponding to the context being accessed in the web application further includes one or more instructions for retrieving the value from a source reference of the web application.
